(19) United States
(12) Patent Application Publication
(10) Pub. No.: US 2014/0307432 A1
(43) Pub. Date: Oct. 16, 2014

(54) ILLUMINATION MODULE

(71) Applicant: DELTA ELECTRONICS, INC., Taoyuan Hsien (TW)

(72) Inventors: Keh-Su Chang, Taoyuan Hsien (TW); Yeong-Feng Wang, Taoyuan Hsien (TW); Meng-Han Liu, Taoyuan Hsien (TW)

(21) Appl. No.: 13/913,667

(22) Filed: Jun. 10, 2013

(30) Foreign Application Priority Data
Apr. 10, 2013 (TW) 102112747

(51) Int. Cl. F21V 5/04

(52) U.S. Cl. CPC F21V 5/04
USPC 362/235

(57) ABSTRACT

An illumination module includes a lens and a plurality of light-emitting elements. The light-emitting elements are symmetrically arranged in a ring shape around a central axis. A plurality of lights are emitted and transmitted to the lens by the light-emitting elements. The lights, which are incident to the lens, are symmetrically arranged in a ring shape around the center of the lens, so that each of the lights transmitted through and outputted from the lens has the same refraction angle as each other. As a result, the tolerance issues are avoided, the fabrication cost and time cost are reduced, the difficulty of fabricating and designing are reduced, and the energies of the focused light point are equally distributed.

### FIELD OF THE INVENTION

The present invention relates to an illumination module, and more particularly to an illumination module arranged with ring-shaped symmetry around a central axis.

### BACKGROUND OF THE INVENTION

In recent years, lot types of projection device such like projectors are widely used in families, schools and business occasions in order to amplify and display an image signal provided by an image source on a screen. For the purpose of enhancing the illumination efficiency, a solid-state light-emitting element is employed in the illumination module of current projector to replace the conventional high intensity discharge (HID) lamp. In addition, for enhancing the total luminance, obtaining a light point having high energy density for exciting a phosphor agent material, and generating color lights having high luminance, the arrangement and the focus method of solid-state light-emitting elements of illumination modules become an important topic of the optical technologies.

Please refer to FIG. 1A and FIG. 1B. FIG. 1A schematically illustrates the structure of a conventional illumination module and an optical path thereof. FIG. 1B schematically illustrates the right view of the illumination module as shown in FIG. 1A. A column and row illumination array is used in conventional illumination module 1 of a conventional projector. A certain number of light-emitting diodes 11 are arranged in each row and each column of the two-dimensional plane. A stepwise mirror 12 is used for minifying the distances between the single-direction light points of rows or columns and reflecting the lights emitted by the light-emitting diodes 11 into an optical path so as to be focused by a lens 13, so that a relatively higher luminance is reached. However, according to the equation of optical invariant (Etendue), the lights emitted by different light-emitting diodes 11 of the conventional illumination module 1 and reflected by the stepwise mirror 12 have different incident angles corresponding to the lens 13 under the factor of the same focus area. Under this circumstance, the lights emitted by the light-emitting diodes 11 have different optical invariants, different incident angles and different focus planes, which cause the plural incident lights cannot be effectively focused on an imaging plane 14 and the energies of light points cannot be homogeneously distributed.

Moreover, because lots of reflecting mirrors and loading and fixing molds are used in designing the mechanism of the stepwise mirror 12, the tolerance issues cannot be avoided, the difficulty of optical corrections is increased, and the illumination efficiency is not matched with the theory value. Not only the fabricating difficulty and cost are raised, but also the time cost of designing an ideal illumination module is increased.

There is a need of providing an illumination module to obviate the drawbacks encountered from the prior art.

### SUMMARY OF THE INVENTION

The present invention provides an illumination module in order to eliminate the drawbacks of the non-homogeneously distribution and the tolerance issues and further to reduce the fabricating cost, the time cost and the difficulty of fabricating and designing.

The present invention also provides an illumination module. By arranging the lights in a ring shape around the center of a lens, each of the lights transmitted through and outputted from the lens has the same refraction angle as each other, and the energies of the focused light point are equally distributed.

The present invention further provides an illumination module. Since the optical polarization direction of each of light-emitting elements is perpendicular to the optical polarization directions of the two adjacent light-emitting elements and the lights are symmetrically arranged in a ring shape and focused by and transmitted through the lens, the ellipse-shaped light points of the light-emitting elements are focused so as to be integrated as circle-shaped light points.

The present invention further provides an illumination module. Via staggering front-row light-emitting elements and back-row light-emitting elements of the light-emitting elements, the product size is effectively reduced and easily designed.

In accordance with an aspect of the present invention, there is provided an illumination module. The illumination module includes a lens and a plurality of light-emitting elements. The light-emitting elements are symmetrically arranged in a ring shape around a central axis. A plurality of lights are emitted to the lens by the light-emitting elements. The lights are symmetrically arranged in a ring shape around the center of the lens. Each of the lights transmitted through and outputted from the lens has the same refraction angle as each other.

In accordance with another aspect of the present invention, there is provided another illumination module. The illumination module includes a lens, a plurality of light-emitting elements and a reflecting mirror. The light-emitting elements are symmetrically arranged in a ring shape around a central axis. A plurality of lights are emitted to the lens by the light-emitting elements. The lights are symmetrically arranged in a ring shape around the center of the lens. Each of the lights transmitted through and outputted from the lens has the same refraction angle as each other. The reflecting mirror is disposed next to the lens for reflecting the lights.

The above contents of the present invention will become more readily apparent to those ordinarily skilled in the art after reviewing the following detailed description and accompanying drawings, in which:

### BRIEF DESCRIPTION OF THE DRAWINGS

FIG. 1A schematically illustrates the structure of a conventional illumination module and an optical path thereof;

FIG. 1B schematically illustrates the right view of the illumination module as shown in FIG. 1A;

FIG. 2A schematically illustrates the structure according to an embodiment of the illumination module of the present invention;

FIG. 2B schematically illustrates the structure of a mold used for holding the illumination module as shown in FIG. 2A;

FIG. 3A schematically illustrates the detailed structure according to an embodiment of the illumination module of the present invention;

FIG. 3B schematically illustrates the right view of the detailed structure of the illumination module as shown in FIG. 3A;

FIG. 4A schematically illustrates the structure of the illumination module that includes light-emitting elements having single one optical polarization direction;

FIG. 4B schematically illustrates the structure of the illumination module that includes light-emitting elements having optical polarization directions perpendicular to the one of adjacent light-emitting element;

FIG. 5A schematically illustrates the structure according to another embodiment of the illumination module of the present invention;

FIG. 5B schematically illustrates the staggered arrangement of the light-emitting elements of the illumination module of the present invention;

FIG. 6A schematically illustrates the rectangular arrangement of the front-row light-emitting elements and the back-row light-emitting elements corresponding to a central axis;

FIG. 6B schematically illustrates the regular pentagon arrangement of the front-row light-emitting elements and the back-row light-emitting elements corresponding to a central axis;

FIG. 6C schematically illustrates the regular hexagon arrangement of the front-row light-emitting elements and the back-row light-emitting elements corresponding to a central axis;

FIG. 7A schematically illustrates the configuration of an illumination module including a reflecting mirror disposed opposite to the light-emitting elements on another side of the lens; and

FIG. 7B schematically illustrates the configuration of an illumination module including a reflecting mirror disposed between the light-emitting elements and the lens in an optical path.

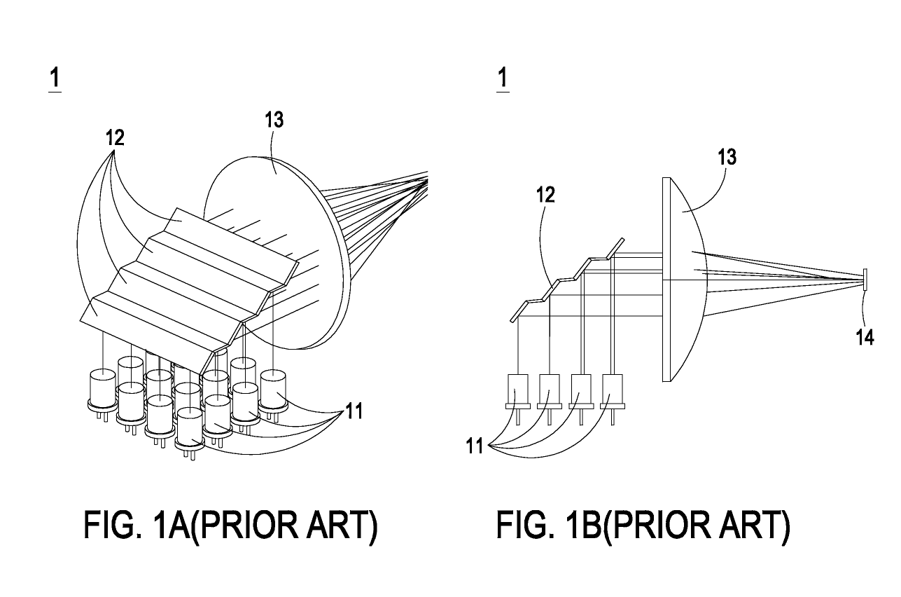

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

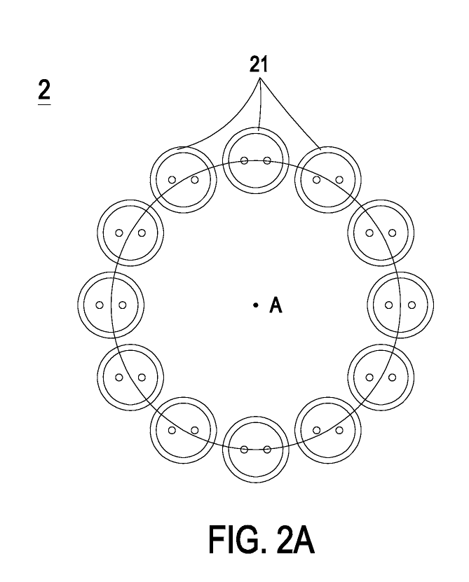

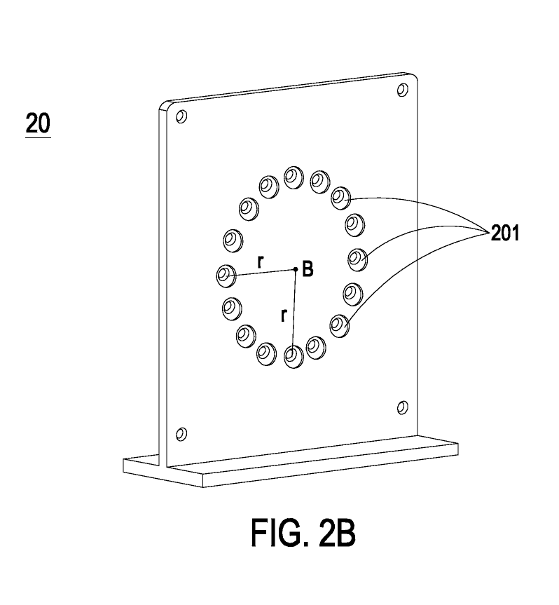

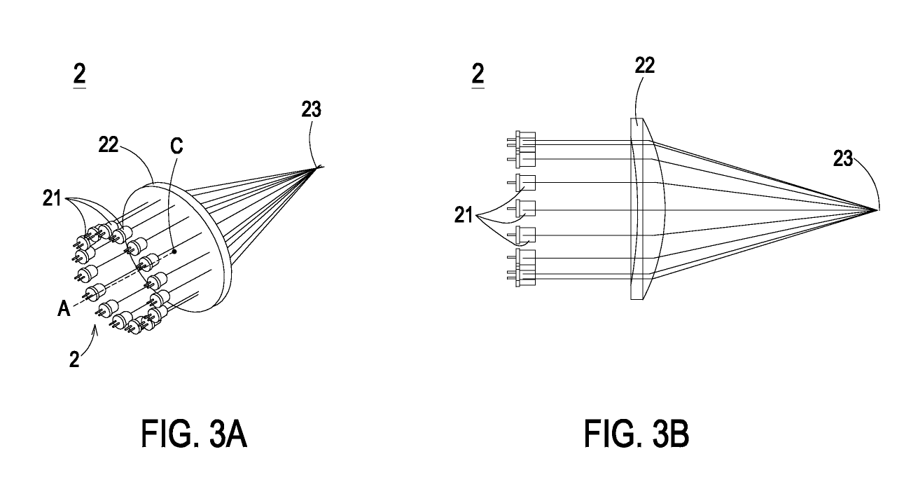

Please refer to FIG. 2A, FIG. 2B, FIG. 3A and FIG. 3B. FIG. 2A schematically illustrates the structure according to an embodiment of the illumination module of the present invention. FIG. 2B schematically illustrates the structure of a mold used for holding the illumination module as shown in FIG. 2A. FIG. 3A schematically illustrates the detailed structure according to an embodiment of the illumination module of the present invention. FIG. 3B schematically illustrates the right view of the detailed structure of the illumination module as shown in FIG. 3A. As shown in FIGS. 2A, 2B, 3A and 3B, the illumination module 2 includes a plurality of light-emitting elements 21 and a lens 22, and the lens 22 is an optical lens having positive power. An example of the lens 22 includes but is not limited to a convex lens, a magnifier and a biconvex lens. The light-emitting elements 21 are symmetrically arranged in a ring shape around a central axis A for emitting a plurality of lights to the lens 22.

In other words, a plurality of lights are emitted and transmitted to the lens 22 by the light-emitting elements 21. The lights, which are incident to the lens 22, are symmetrically arranged in a ring shape around the center C of the lens 22, so that each of the lights transmitted through and outputted from the lens 22 has the same refraction angle as each other (as shown in FIG. 3A and FIG. 3B), and the lights are focused on a focused light point 23. Also, the lights have the same incident angle corresponding to the lens 22 because the refraction rate of the lens 22 is a constant.

Furthermore, the light-emitting elements 21 are arranged in point symmetry and line symmetry along the central axis A, and the lights are arranged in point symmetry and line symmetry along the center C of the lens 22. As a result, the energies of the focused light point are equally distributed by arranging the lights in a ring shape around the center C of the lens 22.

Similar to the design of the symmetrical arrangement mentioned above, the light-emitting elements 21 of the illumination module 2 of the present invention can be disposed in a plurality of perforations 201 of a mold 20. For example, the light-emitting elements 21 are penetrated through or mounted on the perforations 201 of the mold 20, but not limited thereto. Additionally, the central axis A corresponding to the light-emitting elements 21 can be drawn on a point B of the mold 20 for simplifying the fabricating of the mold 20. In brief, the distance between the point B and a center of each perforation 201 is equal to the radius r, which is the radius of a circle along the point B. The perforations 201 are disposed or formed on the same mold 20, so the tolerance issues are avoided without using any conventional stepwise mirror, and the fabricating cost, the time cost and the difficulty of fabricating and designing are reduced.

Please refer to FIG. 3A again. Preferably, the central axis A corresponding to the light-emitting elements 21 of the illumination module 2 of the present invention is directly penetrated through the center C of the lens 22. In some embodiments, the central axis A is indirectly penetrated through the center C of the lens 22 through reflection manners. For example, when the lights emitted by the light-emitting elements 21 are reflected into the optical path to be incident to the lens 22, the angle of the reflection of the lights is applied to the central axis A, so that the central axis A is partially reflected through the center C of the lens 22, but not limited thereto.

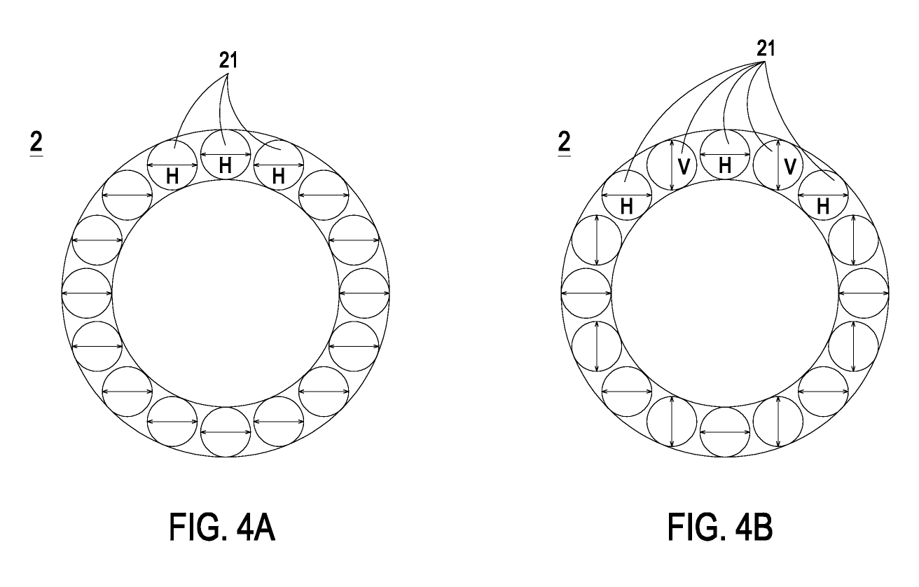

Please refer to FIG. 3A, FIG. 4A and FIG. 4B. FIG. 4A schematically illustrates the structure of the illumination module that includes light-emitting elements having single one optical polarization direction. FIG. 4B schematically illustrates the structure of the illumination module that includes light-emitting elements having optical polarization directions perpendicular to the one of adjacent light-emitting element. The light-emitting elements 21 of the illumination module 2 of the present invention are not limited to light-emitting diodes or laser diodes. If the laser diodes are chose as the light-emitting elements 21, the field or the shape of the light points of the lights emitted by the light-emitting elements 21 is close to an ellipse shape, and the optical polarization directions are linear polarized. Under this circumstance, when the light-emitting elements 21 have the single one optical polarization direction such as a horizontal direction H, the focused light point 23 focused by the lens 22 is a ellipse-shaped light point.

In some embodiments, for the purpose of equally distributing the energies of the focused light point 23, the light-emitting elements 21 having optical polarization directions perpendicular to the one of adjacent light-emitting elements 21 are used in the illumination module 2 of the present invention. As shown in FIG. 4B, two adjacent light-emitting elements 21 have an optical polarization direction in horizontal direction and an optical polarization direction in vertical direction, respectively. In other words, the optical polarization direction of each of the light-emitting elements 21 is perpendicular to the optical polarization directions of two adjacent light-emitting elements 21 but not limited to be in horizontal direction or vertical direction. Preferably, the optical polarization directions can be adjusted for meeting different demands, and the limitation is only that the optical polarization directions of two adjacent light-emitting elements 21 have to be perpendicular to each other. Therefore, the lights emitted by the light-emitting elements 21 and transmitted through the lens 22 are focused on the focused light point 23, which is a circle-shaped light point. That is to say, the present invention achieves the advantages of integrating the field of each light-emitting element 21 from a ellipse-shaped field to a circle-shaped field.

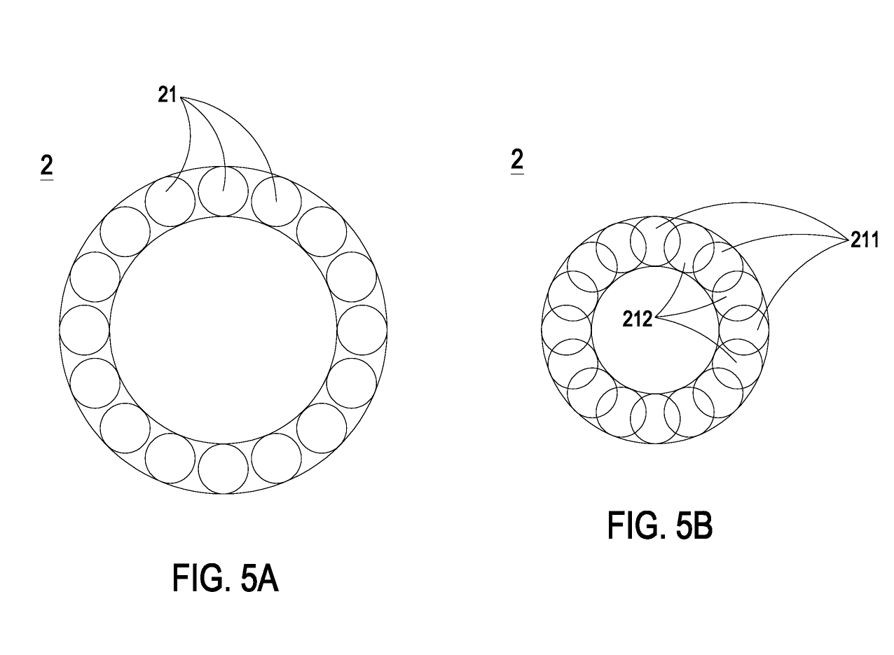

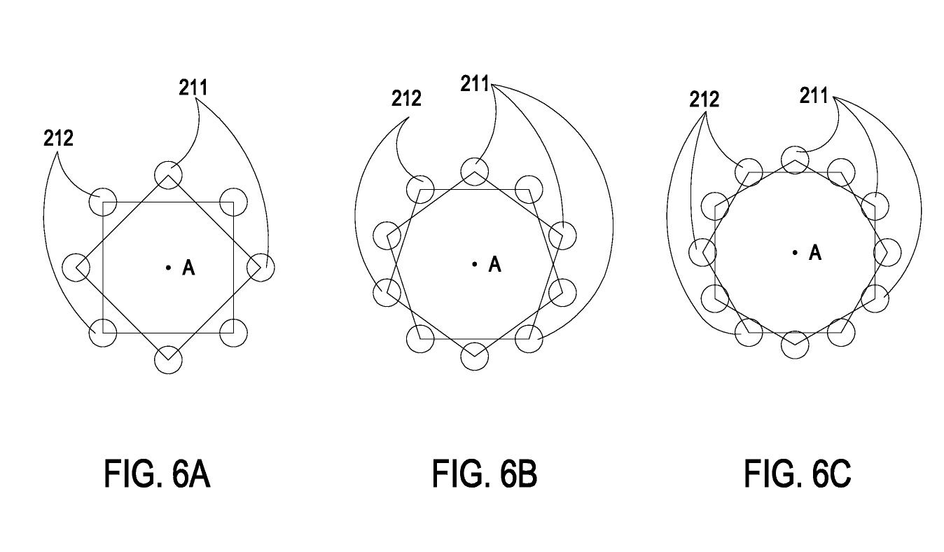

Please refer to FIG. 5A, FIG. 5B, FIG. 6A, FIG. 6B and FIG. 6C. FIG. 5A schematically illustrates the structure according to another embodiment of the illumination module of the present invention. FIG. 5B schematically illustrates the staggered arrangement of the light-emitting elements of the illumination module of the present invention. FIG. 6A schematically illustrates the rectangular arrangement of the front-row light-emitting elements and the back-row light-emitting elements corresponding to a central axis. FIG. 6B schematically illustrates the regular pentagon arrangement of the front-row light-emitting elements and the back-row light-emitting elements corresponding to a central axis. FIG. 6C schematically illustrates the regular hexagon arrangement of the front-row light-emitting elements and the back-row light-emitting elements corresponding to a central axis. Besides the above-mentioned symmetrical arrangement shown in FIG. 5A, the light-emitting elements 21 can be arranged in a staggered arrangement as shown in FIG. 5B. In this embodiment, the light-emitting elements 21 comprise a plurality of front-row light-emitting elements 211 and a plurality of back-row light-emitting elements 212.

The front-row light-emitting elements 211 and the back-row light-emitting elements 212 are arranged in regular polygon shapes corresponding to the central axis A, such like the rectangle, the pentagon or the hexagon (as respectively shown in FIGS. 6A, 6B and 6C). Certainly, the light-emitting elements 21, which are symmetrically arranged in a ring shape as shown in FIG. 5A, can be regarded as a group of odd-numbered light-emitting elements and a group of even-numbered light-emitting elements, among which the group of odd-numbered light-emitting elements and the group of even-numbered light-emitting elements are respectively arranged in regular polygon shapes corresponding to the central axis A. Via staggering the front-row light-emitting elements 211 and the back-row light-emitting elements 212 of the light-emitting elements 21, the space utilization is enhanced, and the product size is effectively reduced and easily designed.

On the other hand, the concept of two perpendicular optical polarization directions of two adjacent light-emitting elements can be applied to the front-row light-emitting elements 211 and the back-row light-emitting elements 212. The optical polarization direction of each of the front-row light-emitting elements 211 is perpendicular to the optical polarization directions of two adjacent back-row light-emitting elements 212, and the optical polarization direction of each of the back-row light-emitting elements 212 is perpendicular to the optical polarization directions of two adjacent front-row light-emitting elements 211. The operation and the characteristic are similar with the above-mentioned embodiments, and not redundantly described herein.

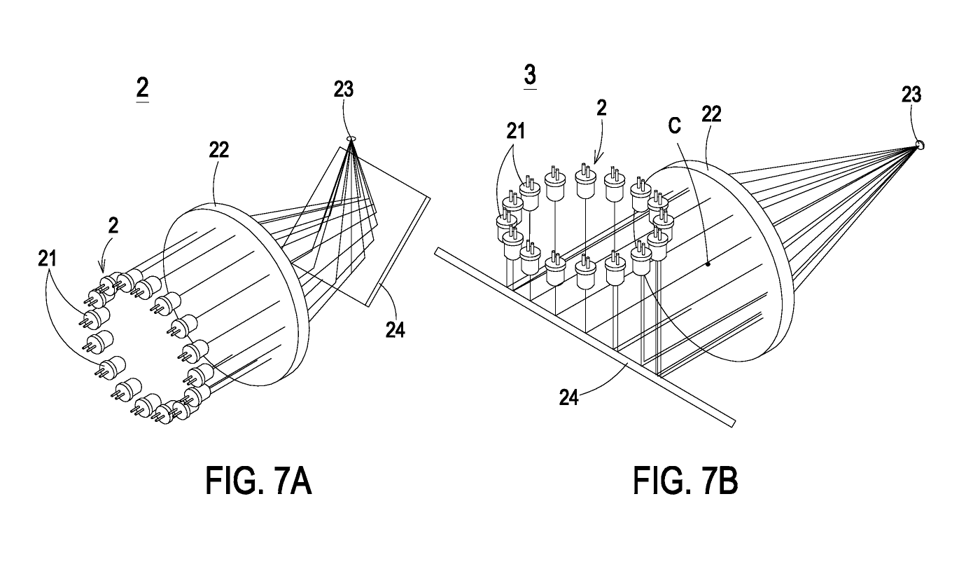

Please refer to FIG. 7A and FIG. 7B. FIG. 7A schematically illustrates the configuration of an illumination module including a reflecting mirror disposed opposite to the light-emitting elements on another side of the lens. FIG. 7B schematically illustrates the configuration of an illumination module including a reflecting mirror disposed between the light-emitting elements and the lens in an optical path. As shown in FIGS. 7A and 7B, the illumination module 2 of the present invention further includes a reflecting mirror 24. The reflecting mirror 24 is disposed opposite to the light-emitting elements 21 on another side of the lens 22 for reflecting the lights transmitted through the lens 22, and then the lights are focused on the focused light point 23. In some embodiments, the reflecting mirror 24 is disposed between the light-emitting elements 21 and the lens 22 in the optical path for reflecting the lights to be incident to the lens 22, and the lights are symmetrically arranged in a ring shape around the center C of the lens 22 and have the same incident angle. In brief, the reflecting mirror 24 is disposed next to the lens 22 for reflecting the lights, and is preferably disposed according to the requirements of space arrangement for meeting the demands of reflecting an optical path.

From the above description, the present invention provides an illumination module. By arranging the lights in a ring shape around the center of a lens, each of the lights transmitted through and outputted from the lens has the same refraction angle as each other, and the energies of the focused light point are equally distributed. Meanwhile, since the optical polarization direction of each of light-emitting elements is perpendicular to the optical polarization directions of the two adjacent light-emitting elements and the lights are symmetrically arranged in a ring shape and focused by and transmitted through the lens, the ellipse-shaped light points of the light-emitting elements are focused so as to be integrated as circle-shaped light points. In addition, via staggering front-row light-emitting elements and back-row light-emitting elements of the light-emitting elements, the product size is effectively reduced and easily designed.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An illumination module, comprising:
a lens; and
a plurality of light-emitting elements symmetrically arranged in a ring shape around a central axis,
wherein a plurality of lights are emitted to said lens by said light-emitting elements, said lights are symmetrically arranged in a ring shape around the center of said lens, and each of said lights transmitted through and outputted from said lens has the same refraction angle as each other.

2. The illumination module according to claim 1, wherein said lights have the same incident angle corresponding to said lens.

3. The illumination module according to claim 1, wherein said light-emitting elements are arranged in point symmetry and line symmetry along said central axis.

4. The illumination module according to claim 1, wherein said lights are arranged in point symmetry and line symmetry along the center of said lens.

5. The illumination module according to claim 1, wherein the optical polarization direction of each of said light-emitting elements is perpendicular to the optical polarization directions of two adjacent said light-emitting elements, wherein said lights emitted by said light-emitting elements and transmitted through said lens are focused on a focused light point, and wherein said focused light point is a circle-shaped light point.

6. The illumination module according to claim 1, wherein said light-emitting elements comprise a plurality of front-row light-emitting element and a plurality of back-row light-emitting elements, and said front-row light-emitting elements and said back-row light-emitting elements are arranged in regular polygon shapes corresponding to said central axis.

7. The illumination module according to claim 6, wherein the optical polarization direction of each of said front-row light-emitting elements is perpendicular to the optical polarization directions of two adjacent said back-row light-emitting elements, and wherein the optical polarization direction of each of said back-row light-emitting elements is perpendicular to the optical polarization directions of two adjacent said front-row light-emitting elements.

8. The illumination module according to claim 1 further comprises a reflecting mirror, wherein said reflecting mirror is disposed opposite to said light-emitting elements on another side of said lens for reflecting said lights transmitted through said lens, and said lights are focused on a focused light point.

9. The illumination module according to claim 1 further comprises a reflecting mirror, wherein said reflecting mirror is disposed between said light-emitting elements and said lens in an optical path for reflecting said lights to be incident to said lens, and said lights are symmetrically arranged in a ring shape around the center of said lens and have the same incident angle.

10. An illumination module, comprising:
a lens;
a plurality of light-emitting elements symmetrically arranged in a ring shape around a central axis,
wherein a plurality of lights are emitted to said lens by said light-emitting elements, said lights are symmetrically arranged in a ring shape around the center of said lens, and each of said lights transmitted through and outputted from said lens has the same refraction angle as each other; and
a reflecting mirror disposed next to said lens for reflecting said lights.
